(19) United States
(12) Patent Application Publication
(10) Pub. No.: US 2015/0121278 A1
(43) Pub. Date: Apr. 30, 2015

(54) METHOD AND APPARATUS FOR PROVIDING USER INTERFACE IN MULTI-WINDOW

(71) Applicant: Samsung Electronics Co., Ltd., Suwon-si (KR)

(72) Inventors: Hyunjae KIM, Suwon-si (KR); Myungsu KANG, Seoul (KR)

(21) Appl. No.: 14/525,479

(22) Filed: Oct. 28, 2014

(30) Foreign Application Priority Data
Oct. 30, 2013 (KR) 10-2013-0130085

(51) Int. Cl. G06F 3/0488; G06K 9/00; G06F 3/0484

(52) U.S. Cl. CPC G06F 3/04886; G06F 3/04847; G06F 3/04842; G06K 9/00369
USPC 715/771

(57) ABSTRACT

A method and apparatus for providing a user interface in a multi-window are provided. The method includes determining an output path for each window contained in the multi-window, and providing an output signal associated with each window to an output unit corresponding to the determined output path.

### CROSS-REFERENCE TO RELATED APPLICATION(S)

This application claims the benefit under 35 U.S.C. §119(a) of a Korean patent application filed on Oct. 30, 2013 in the Korean Intellectual Property Office and assigned Serial number 10-2013-0130085, the entire disclosure of which is hereby incorporated by reference.

### TECHNICAL FIELD

The present disclosure relates to a technique to provide a user interface in a multi-window. More particularly, the present disclosure relates to independently controlling a user interface for each window in a multi-window environment.

### BACKGROUND

With the extensive growth of related technologies, contemporary mobile devices, e.g., tablets and smart phones, offer a great variety of services based on a wireless internet environment, as well as offering traditional services such as a voice call, a short message service, and the like.

Many contemporary mobile devices have the ability to provide a multi-tasking function for offering two or more services at the same time. For example, a user can take notes while talking over the phone, or listen to music and play a game application simultaneously. However, such multi-tasking functions have the drawback of failing to display two or more application windows on the screen at the same time. Therefore, a user has no choice but to open respective windows alternately.

As such, some mobile devices now provide a multi-window environment in which two application windows can be displayed on the screen simultaneously. However, both windows share the same output path, for example, both windows must share an audio output signal.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide techniques to independently control a user interface for each window in a multi-window environment, thus utilizing a single user interface apparatus like two or more user interface apparatuses.

Another aspect of the present disclosure is to provide a method for providing a user interface in a multi-window on a device. This method comprises determining an output path for each window contained in the multi-window, and providing an output signal associated with each window to an output unit corresponding to the determined output path.

Another aspect of the present disclosure is to provide a user interface apparatus in a multi-window. The user interface apparatus comprises a path determining unit configured to determine an output path for each window contained in the multi-window, and a signal providing unit configured to provide an output signal associated with each window to an output unit corresponding to the determined output path.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating a user interface apparatus in a multi-window according to various embodiments of the present disclosure.

FIGS. 2A, 2B, and 2C are user interface illustrations demonstrating examples of determining an output path according to various embodiments of the present disclosure.

FIGS. 3A and 3B are user interface illustrations demonstrating examples of selecting an output unit by a user according to various embodiments of the present disclosure.

FIGS. 4A and 4B are user interface illustrations demonstrating examples of determining an output path for the second application according to various embodiments of the present disclosure.

FIGS. 5A and 5B are user interface illustrations demonstrating examples of recommending an output unit on the basis of the characteristic of an application according to various embodiments of the present disclosure.

FIGS. 6A and 6B are user interface illustrations demonstrating examples of controlling the output of an output unit according to various embodiments of the present disclosure.

FIG. 7 is a flow diagram illustrating a method for providing a user interface in a multi-window according to various embodiments of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a signal” includes reference to one or more of such signals.

In this disclosure, a user interface apparatus configured for a multi-window may be included in an electronic device, which may involve a communication function. For example, an electronic device may be a smart phone, a tablet Personal Computer (PC), a mobile phone, a video phone, an e-book reader, a desktop PC, a laptop PC, a netbook computer, a Personal Digital Assistant (PDA), a Portable Multimedia Player (PMP), an MP3 player, a portable medical device, a digital camera, or a wearable device (e.g., a Head-Mounted Device HMD) such as electronic glasses, electronic clothes, an electronic bracelet, an electronic necklace, an electronic accessory, or a smart watch). According to some embodiments, an electronic device may be a smart home appliance that involves a communication function. For example, an electronic device may be a TV, a Digital Video Disk (DVD) player, audio equipment, a refrigerator, an air conditioner, a vacuum cleaner, an oven, a microwave, a washing machine, an air cleaner, a set-top box, a TV box (e.g., Samsung HomeSync™, Apple TV™, Google TV™, etc.), a game console, an electronic dictionary, an electronic key, a camcorder, or an electronic picture frame. According to some embodiments, an electronic device may be a medical device (e.g., Magnetic Resonance Angiography (MRA), Magnetic Resonance Imaging (MRI), Computed Tomography (CT), ultrasonography, etc.), a navigation device, a Global Positioning System (GPS) receiver, an Event Data Recorder (EDR), a Flight Data Recorder (FDR), a car infotainment device, electronic equipment for ship (e.g., a marine navigation system, a gyrocompass, etc.), avionics, security equipment, or an industrial or home robot. According to some embodiments, an electronic device may be furniture or part of a building or construction having a communication function, an electronic board, an electronic signature receiving device, a projector, or various measuring instruments (e.g., a water meter, an electric meter, a gas meter, a wave meter, etc.). An electronic device disclosed herein may be one of the above-mentioned devices or any combination thereof As well understood by those skilled in the art, the above-mentioned electronic devices are exemplary only and not to be considered as a limitation of this disclosure.

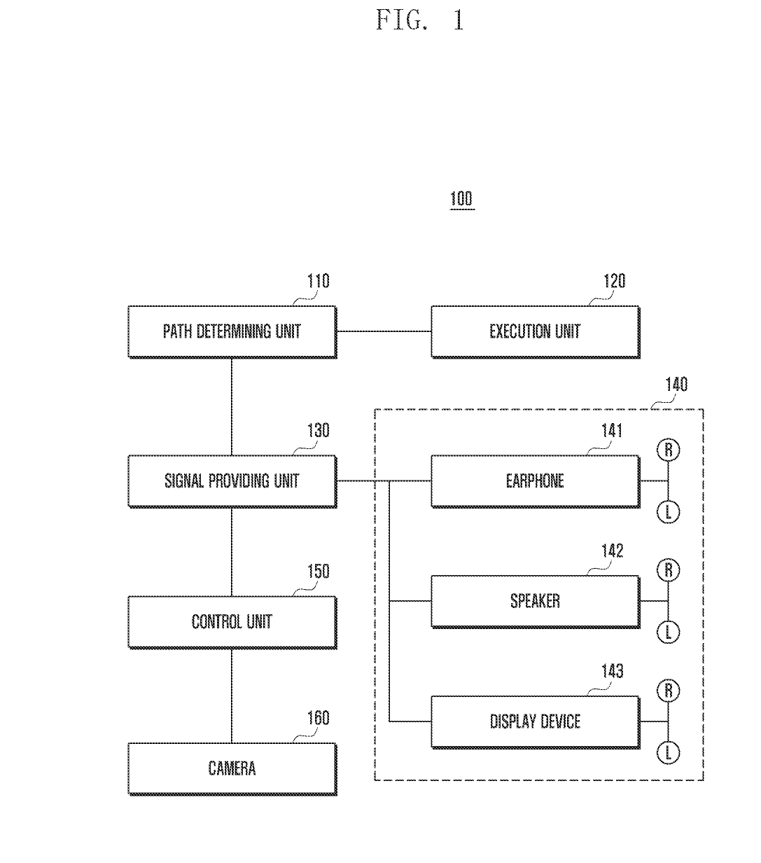

FIG. 1 is a block diagram illustrating a user interface apparatus in a multi-window according to various embodiments of the present disclosure.

Referring to FIG. 1, a user interface apparatus 100 in the multi-window may include a path determining unit 110, an execution unit 120, a signal providing unit 130, an output unit 140, a control unit 150, and a camera 160. In various embodiments, the output unit 140 may include a sound output device such as an earphone 141 and/or a speaker 142, and/or a display device 143 such as a monitor and/or a TV.

The path determining unit 110 determines an output path for each window of the multi-window.

The multi-window refers to an environment capable of simultaneously displaying two application windows on the screen. Typically, the multi-window focuses on a single user environment in which a single user can execute two or more applications at the same time. However, as the size of the screen of a user interface apparatus increases, two or more users often use the same user interface apparatus at the same time. In this case, interference may be caused between some users.

For example, in a case where two or more multimedia contents are played at the same time, their sound outputs may be mixed unfavorably. Additionally, in a case where an incoming call arrives during the playback of multimedia content, a multi-window function may be suspended. Then, one user may exclusively use the user interface apparatus, and hence the others may be unable to use the user interface apparatus.

Meanwhile, there is a technique to selectively offer a sound source to a specific user only. By radiating a beam to users as if in a directional speaker, this technique allows each individual user to listen only to a selected sound. However, this technique may fail to support various sound output devices. That is, such a sound separation technique may be available only for a specific sound output environment based on fixed hardware, such as Bluetooth or a directional speaker. Further, since the screen of the user interface apparatus can only display the last executed application, it may fail to satisfy all users.

According to an embodiment of this disclosure, a user interface is controlled independently for each window in a multi-window environment. It is therefore possible to utilize a single user interface apparatus like two or more user interface apparatuses.

Further, embodiments of this disclosure allow utilizing a single electronic device as a multi-electronic device. Specifically, in a multi-window environment, it is possible to separate a sound source according to each input or output device, to separately offer audio and video data to each user, and to prevent one user from exclusively using the user interface apparatus.

In an embodiment of this disclosure, an output unit for separately and independently outputting a sound may be determined on the basis of information about locations of currently activated windows of multi-window and/or a user's intention. In some embodiments, any combination of output units may be allowed as well as a sound separation.

According to various embodiments of this disclosure, two users who use only one electronic device (e.g., a mobile device) and respective earphones may listen to different music albums. Alternatively, one user may listen to music, and the other may see a movie. If two users see a movie together and if an incoming call arrives, one user may receive a call by using a right window and a hands-free device, and the other may see continuously a movie by using a left window and a speaker.

For this, the path determining unit 110 may determine an output path for each window of the multi-window.

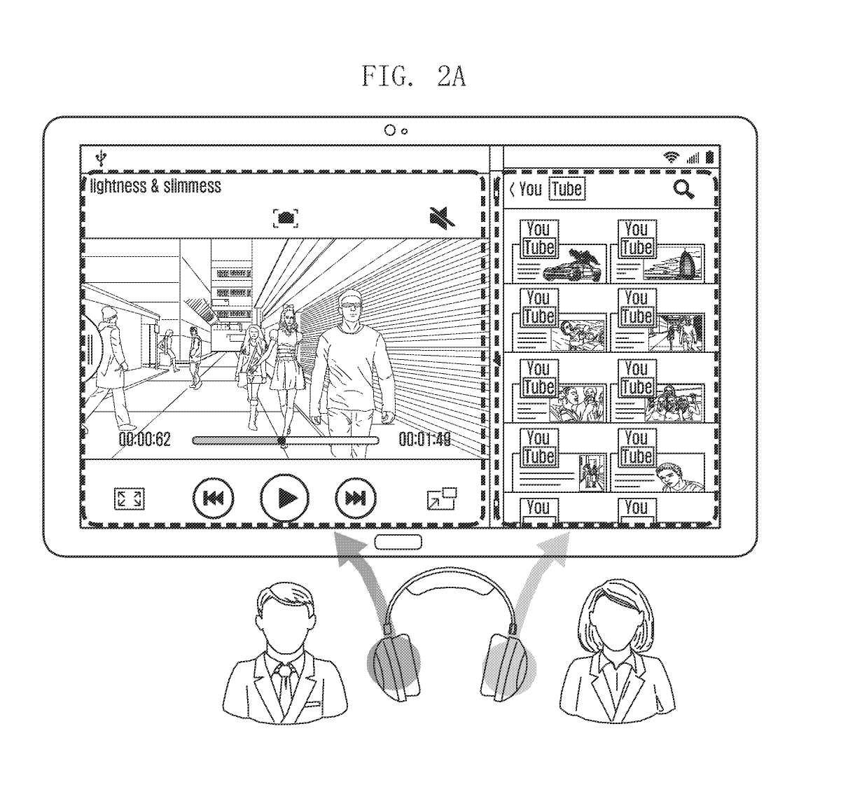

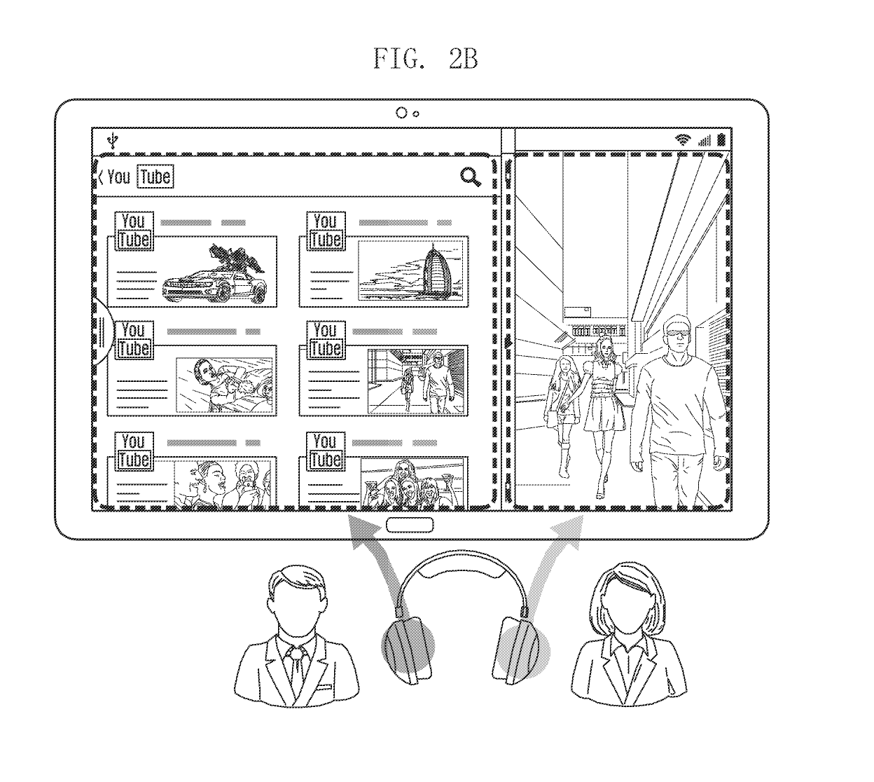

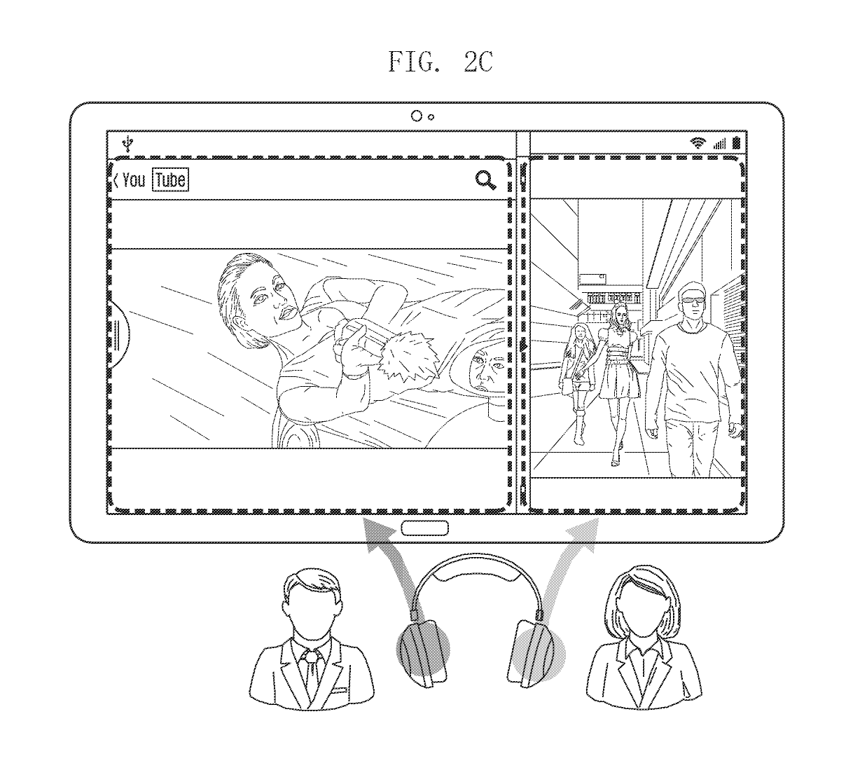

FIGS. 2A, 2B, and 2C are user interface illustrations demonstrating examples of determining an output path according to various embodiments of the present disclosure.

Referring to FIG. 2A, the path determining unit 110 may assign a display region to each window contained in the multi-window and, based on the display region, determine an output path. For example, if the multi-window has two windows therein as shown in FIG. 2A, the path determining unit 110 may identify left and right display regions corresponding to a first window and a second window, respectively, select a left output unit as an output path for the left display region, and select a right output unit as an output path for the right display region. Specifically, in FIG. 2A, the left display region may display thereon a movie, and the right display region may display thereon a video or a video list. Also, the output unit 140 may be the earphone 141. Therefore, depending on such display regions, the path determining unit 110 may provide different output signals to the left part (L) and right part (R) of the earphone 141, respectively.

Referring to FIG. 2B, the path determining unit 110 may identify a disposition of an application currently executed in each window and, based on the disposition, determine an output path. For example, in a case where the first application (e.g., the first movie) is executing in the left window, the path determining unit 110 may select the left part (L) of the earphone 141 as an output path for the first application. Similarly, in a case where the second application (e.g., the second movie) is executing in the right window, the path determining unit 110 may select the right part (R) of the earphone 141 as an output path for the second application.

Using the same user interface apparatus 100, two users can execute different applications at the same time. In this case, output signals associated with such applications can be offered through different output paths without being mixed unfavorably.

That is, the path determining unit 110 may determine an output path depending on the display region of each individual window or the disposition of each individual application.

Referring to FIG. 2C, the path determining unit 110 may identify characteristics of an application currently executed in each window and, based on such characteristics, determine an output path. For example, in a case where the first application executing in the first window is a webpage, the path determining unit 110 may select an output path such that the first output signal from the first application will be outputted to the earphone 141. Similarly, in a case where the second application executing in the second window is a movie, the path determining unit 110 may select an output path such that the second output signal from the second application will be outputted to the speaker 142. In this case, the path determining unit 110 may determine whether an output unit appropriate for the characteristic of a specific application is connected or not, and then determine an output path in consideration of the connected output unit.

The user interface apparatus 100 may further include a wirelessly connected output unit as well as a wired output unit. In the case of a movie, an audio signal might be better outputted through the speaker 142 rather than through the earphone 141. Also, a video signal might be better displayed on the display unit 143 such as a monitor or TV, having a relatively large-sized display region, rather than on the user interface apparatus 100. Therefore, considering that the characteristic of an application is that of a movie, the path determining unit 110 may determine whether the speaker 142 and/or the display unit 143 are connected to the user interface apparatus 100, and then select the speaker 142 and/or the display unit 143 as an output path for a movie. For example, for a movie application, the path determining unit 110 may determine the speaker 142 and the display device 143 as an audio output path and a video output path, respectively.

In an embodiment, the path determining unit 110 may recommend one or more output units, based on the characteristic of an application executing in each window, and then determine an output path in connection with the output unit 140 selected from among the recommended output units by a user.

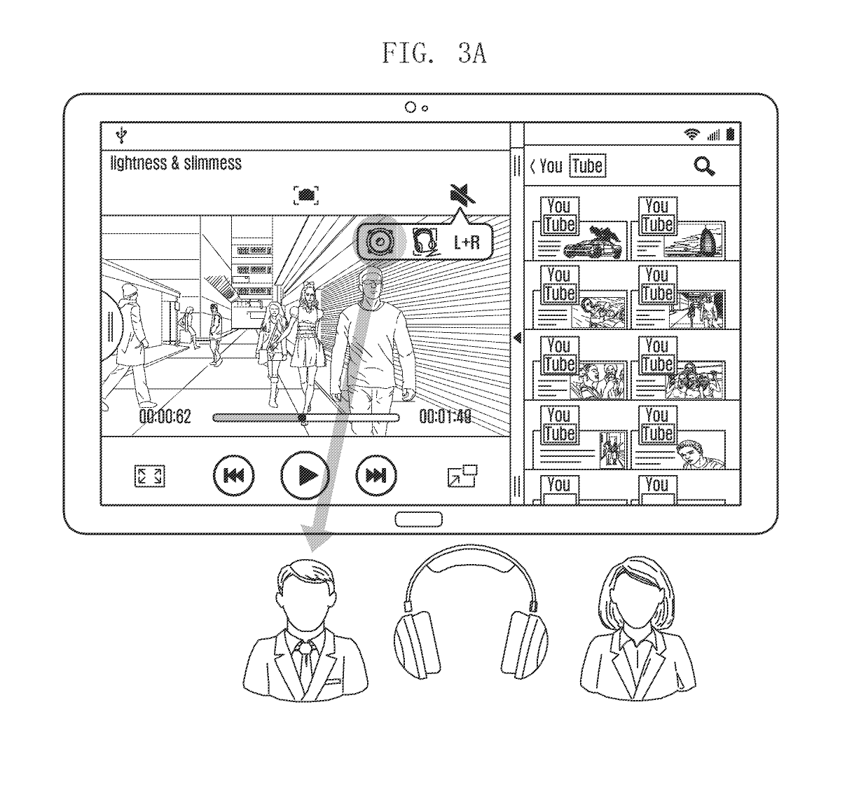

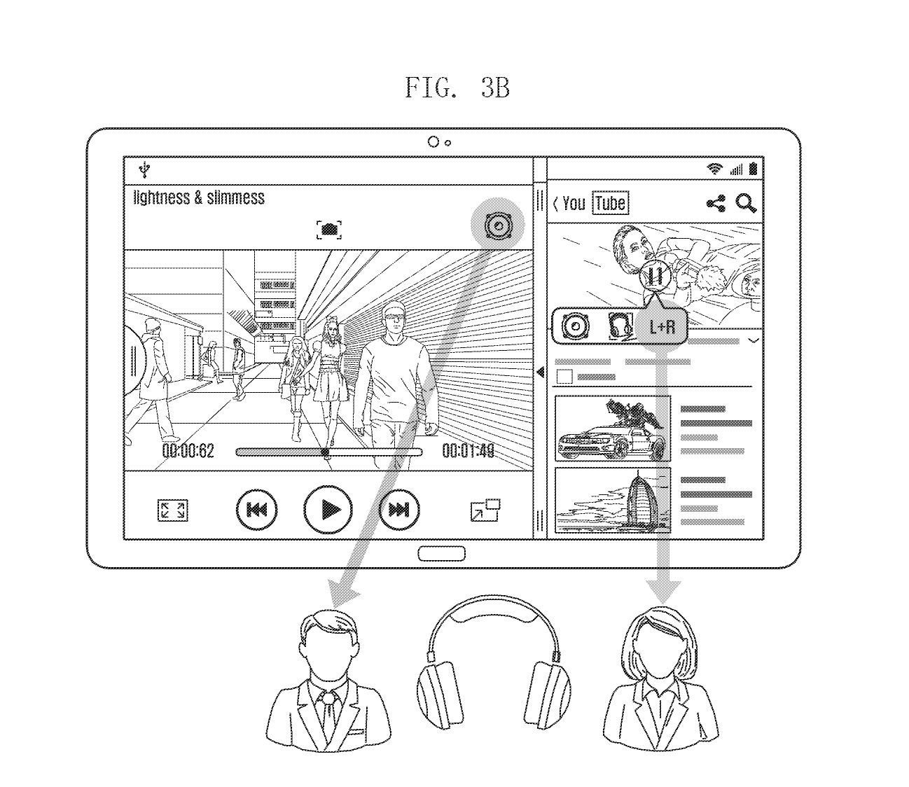

FIGS. 3A and 3B are user interface illustrations demonstrating examples of selecting an output unit by a user according to various embodiments of the present disclosure.

Referring to FIG. 3A, the path determining unit 110 may recommend output units (e.g., a speaker, an earphone, a left part, a right part, etc.) on the basis of the characteristics of an application that is currently executed by the execution unit 120. Based on a user's selection, the path determining unit 110 may determine an output path in connection with a specific output unit (e.g., a speaker) selected from among the recommended output units.

Referring to FIG. 3B, the path determining unit 110 may offer a list of output units (e.g., a speaker, an earphone, a left part, a right part, etc.) and receive a user's response of selecting a specific output unit (e.g., an earphone) in the list. The path determining unit 110 may determine an output path in connection with the selected output unit (e.g., an earphone).

The signal providing unit 130 provides an output signal associated with each window to the output unit 140 corresponding to the selected output path. For example, the signal providing unit 130 may provide an output signal to the left part of the earphone 141 for the first window and also provide an output signal to the right part of the earphone 141 for the second window. Alternatively, the signal providing unit 130 may provide an output signal to the earphone 141 for the first application and also provide an output signal to the speaker 142 for the second application.

In an embodiment, the second application may be invoked while the first application has been already executed and an output signal associated with the first application is currently provided through a selected output unit. The path determining unit 110 may determine an output path for the second application, independently of a current output path.

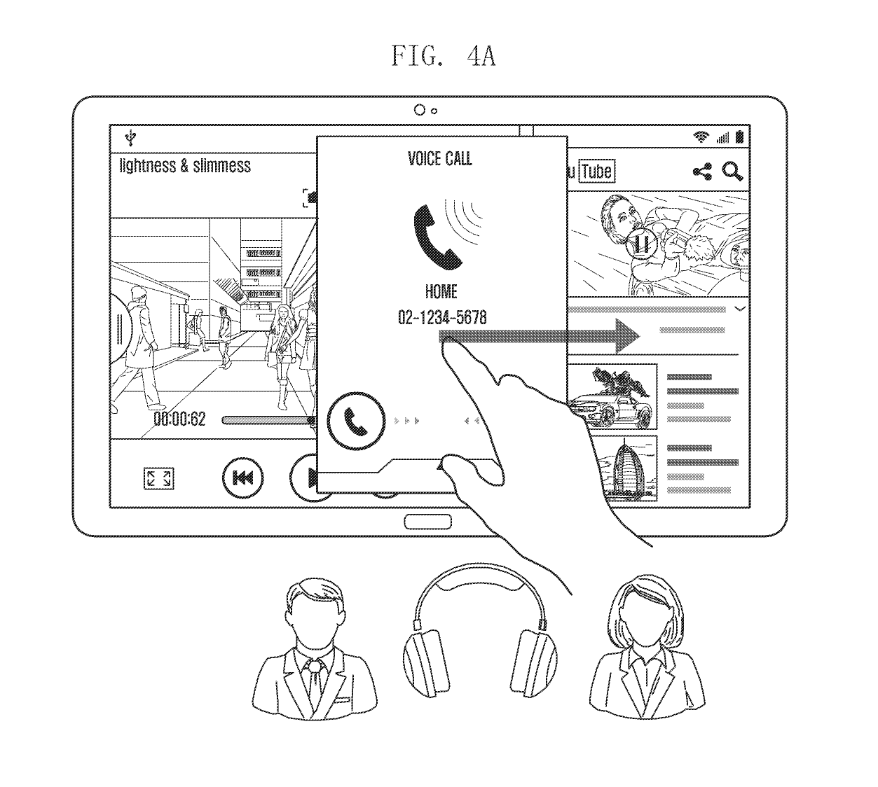

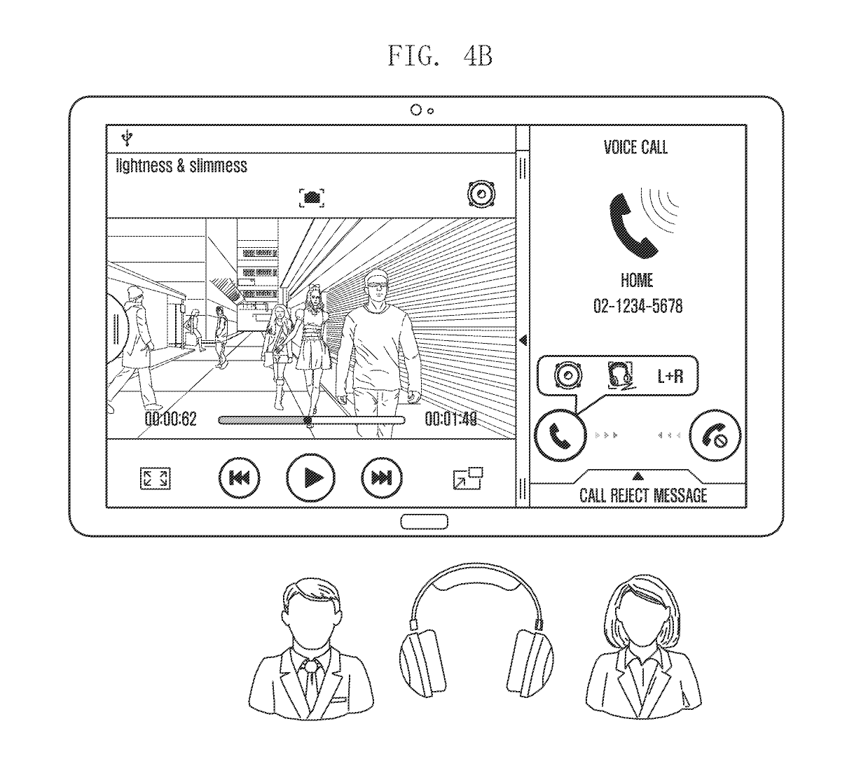

FIGS. 4A and 4B are user interface illustrations demonstrating examples of determining an output path for the second application according to various embodiments of the present disclosure.

Referring to FIG. 4A, if a music application is executing in the first window (e.g., the left window) and if a movie application is executing in the second window (e.g., the right window), the signal providing unit 130 may provide an output signal of the music application to the earphone 141 and also provide an output signal of the movie application to the speaker 142. In this case, if an incoming call arrives, the path determining unit 110 regards the arrival of the incoming call as the invocation of the second application. Therefore, the path determining unit 110 may determine the output unit 140 to which an output signal of the second application will be outputted.

Referring to FIG. 4A, when the second application is executed, the path determining unit 110 may receive a user's manipulation to select a specific window for displaying the second application. The path determining unit 110 may determine an output path for the second application in connection with the selected window.

Alternatively, referring to FIG. 4B, the path determining unit 110 may recommend one or more output units in consideration of the characteristic of the second application. Based on a user's response of selecting a specific one of the recommended output units, the path determining unit 110 may determine an output path for the selected output unit. For example, in a case where the second application is a voice call, the path determining unit 110 may recommend the earphone 141 as an output unit among the earphone 141, the speaker 142, and an external speaker because a voice call may be usually a private affair. Additionally, in a case where the second application is a video call, the path determining unit 110 may recommend the speaker 142 because a video call may be sometimes a group call or a conference call.

When the second application is invoked, the path determining unit 110 may select, as an output path for the second application, an output unit which is predetermined in connection with the second application. For example, in a case where the second application is a voice call, the path determining unit 110 may predetermine the earphone 141 as the output unit 140 for a voice call.

If a predetermined output unit is already in use, the path determining unit 110 may recommend one or more second output units instead of the predetermined output unit. The path determining unit 110 may determine, as an output path for the second application, the second output unit selected from among the recommended output units by a user. For example, if the earphone is a predetermined output unit and is currently in use, the path determining unit 110 may recommend the speaker as the second output unit instead of the earphone and, with a user's approval, determine the speaker as an output path for the second application.

Alternatively, in a case where a predetermined output unit is in use, the path determining unit 110 may receive a user's input of selecting an output path for the second application. For example, if the earphone is a predetermined output unit and is currently in use, the path determining unit 110 may offer a list of output units including the earphone and receive a user's input of selecting output unit in the list. The path determining unit 110 may determine a user's selected output unit as an output path for the second application. In this case, the path determining unit 110 may further offer an alert notification that a currently used output path is not allowed to be changed or to be used as an output path for the second application.

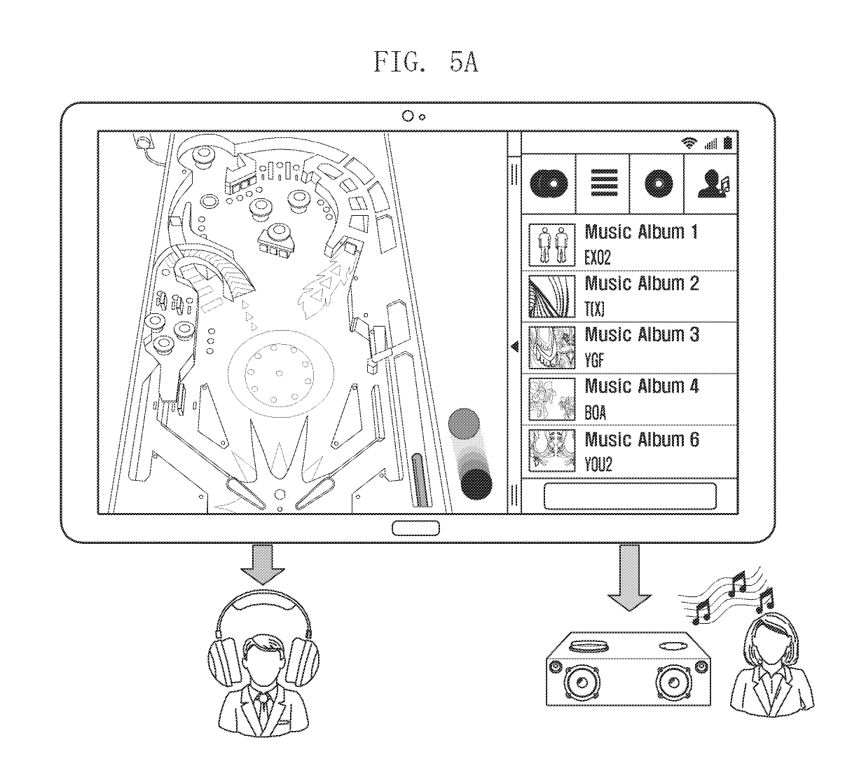

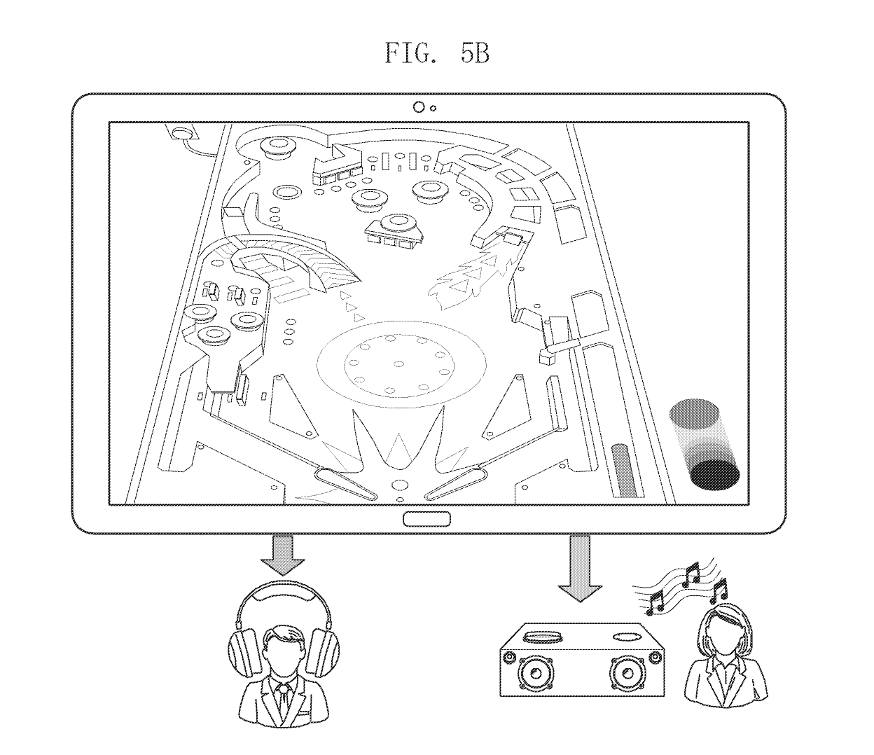

FIGS. 5A and 5B are user interface illustrations demonstrating examples of recommending an output unit on the basis of the characteristic of an application according to various embodiments of the present disclosure.

Referring to FIG. 5A, the path determining unit 110 may determine an output path depending on the characteristic of an application which is executed in each window. For example, if the first application executed in the first window is a game, the path determining unit 110 may select an earphone as an output path. If the second application executed in the second window is a music album, the path determining unit 110 may select a speaker as an output path.

Referring to FIG. 5B, the signal providing unit 130 may provide an output signal associated with each window to the output unit corresponding to the selected output path, whereas the control unit 150 may control the screen of the user interface apparatus 100 to display thereon only the first application. For example, if only one of the users plays a game and if the others listen to music, there may be no need to display a music application separately. Therefore, the control unit 150 may control the screen of the user interface apparatus 100 to display the first application (i.e., game) alone without displaying the second application (i.e., music).

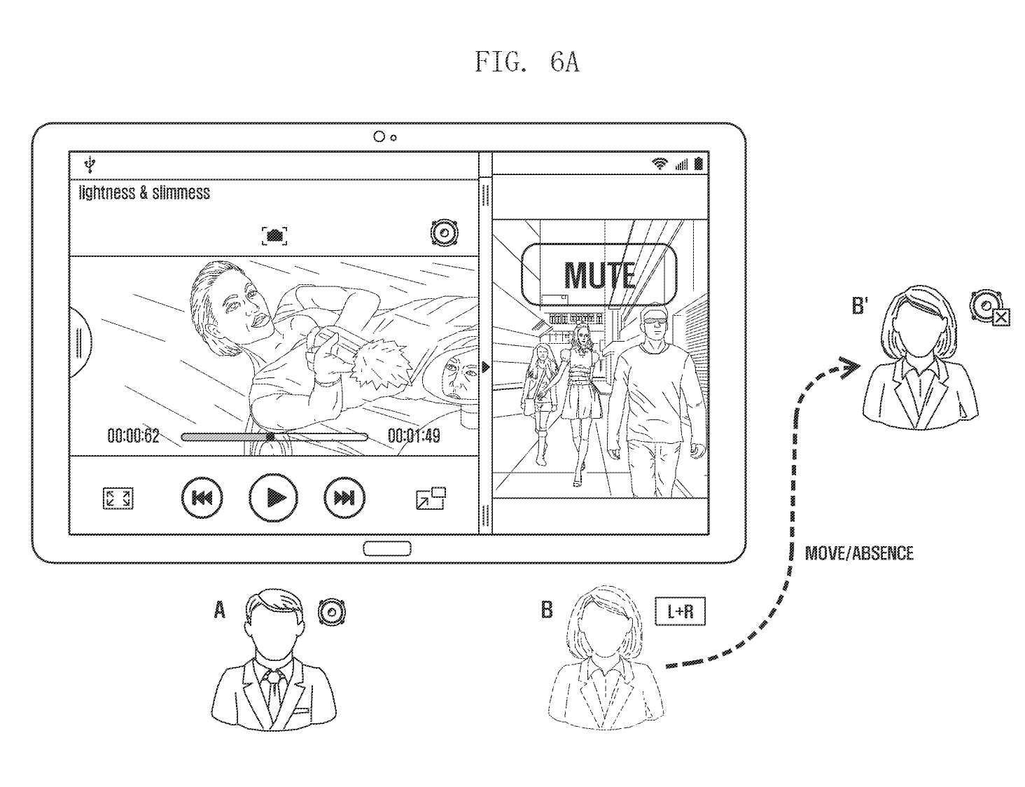

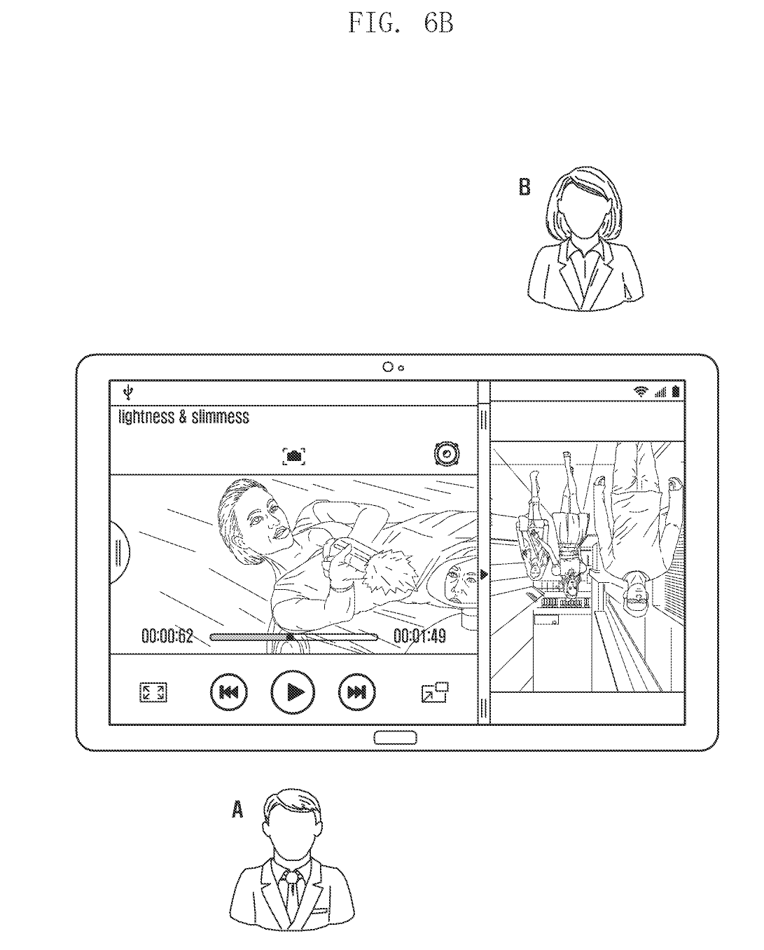

FIGS. 6A and 6B are user interface illustrations demonstrating examples of controlling the output of an output unit according to various embodiments of the present disclosure.

Referring to FIG. 6A, the control unit 150 may determine, using the camera 160, whether a user associated with each window is visibly present. Depending on whether a user is present or not, the control unit 150 may control the output of the output unit 140. For example, if it is recognized through the camera 160 that a right user (B) is not present, the control unit 150 may set the output value of the right output unit 140 to zero. This may result in a reduction of power consumption by removing any unnecessary output signal.

Referring to FIG. 6B, using the camera 160, the control unit 150 may recognize the location of a user (A, B) associated with each window and then control the output value of the output unit 140 on the basis of the recognized location. Additionally, the control unit 150 may control the output value of the output unit 140 in response to a user's command. For example, the control unit 150 may receive a command to turn over the screen of the second application from a user (B) and then control the screen of the second application to be turned over. Instead of using the camera 160, the control unit 150 may use a gyro sensor, an acceleration sensor, or the like to recognize the location of users (A and B) associated with respective windows.

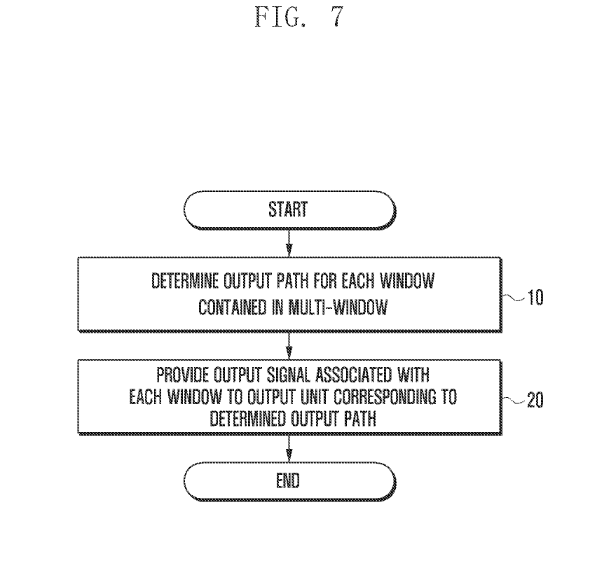

FIG. 7 is a flow diagram illustrating a method for providing a user interface in a multi-window according to various embodiments of the present disclosure. This method may be performed by the user interface apparatus 100.

Referring to FIG. 7, at operation 10, the path determining unit 110 of the user interface apparatus 100 determines an output path for each window contained in the multi-window. In various embodiments, the path determining unit 110 may assign a display region to each window in the multi-window and, based on the display region, determine an output path. In various embodiments, the path determining unit 110 may identify a disposition and/or orientation of an application executing in each window and, based on the disposition and/or orientation, determine an output path. In various embodiments, the path determining unit 110 may identify the characteristic of an application currently executed in each window and, based on such characteristic, determine an output path. In this case, the path determining unit 110 may determine whether an output unit appropriate for the characteristic of a specific application is connected, and then determine an output path in consideration of the connected output unit.

In various embodiments, the path determining unit 110 may recommend one or more output units, based on the characteristic of an application executing in each window, and then determine an output path in connection with the output unit 140 selected from among the recommended output units by a user.

In various embodiments, the path determining unit 110 may offer a list of output units and receive a user's response of selecting an output unit in the list. The path determining unit 110 may determine an output path in connection with the selected output unit.

At operation 20, the signal providing unit 130 of the user interface apparatus 100 provides an output signal associated with each window to an output unit corresponding to the determined output path.

In various embodiments, when the second application is executed, the path determining unit 110 may receive a user's input of selecting a window for displaying the second application and determine, as an output path for the second application, an output path associated with the selected window. Alternatively, the path determining unit 110 may determine, as an output path for the second application, an output unit that is predetermined in connection with the second application.

The control unit 150 of the user interface apparatus 100 may determine, using the camera 160, whether a user associated with each window is visibly present. Depending on whether a user is present or not, the control unit 150 may control the output value of the output unit 140. Alternatively, the control unit 150 may recognize the location of a user associated with each window and then control the output value of the output unit 140 on the basis of the recognized location.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for providing a user interface in a multi-window displayed on a device, the method comprising:
determining an output path for each window contained in the multi-window; and
providing an output signal associated with each window to an output unit corresponding to the determined output path.

2. The method of claim 1, wherein the determining of the output path includes:
assigning a display region to each window in the multi-window; and
determining the output path based on the display region.

3. The method of claim 1, wherein the determining of the output path includes:
identifying an orientation of an application or a disposition of an application executing in each window; and
determining the output path based on the disposition or the orientation.

4. The method of claim 1, wherein the determining of the output path includes:
identifying a characteristic of an application executing in each window; and
determining the output path based on the identified characteristic.

5. The method of claim 4, wherein the determining of the output path based on the identified characteristic includes:
determining whether an output unit is connected that is appropriate for the characteristic of the application; and
determining the output path based on the connection of an appropriate output unit.

6. The method of claim 1, wherein the determining of the output path includes:
recommending one or more output units based on a characteristic of an application executing in each window; and
determining the output path corresponding to an output unit selected by a user from among the recommended output units.

7. The method of claim 1, wherein the determining of the output path includes:
providing a list of output units;
receiving a user response that selects an output unit in the list; and
determining the output path corresponding to the selected output unit.

8. The method of claim 1, wherein the determining of the output path includes:
when a second application is executed, receiving a user input that selects a window for displaying the second application; and
determining an output path for the second application corresponding to an output path associated with the selected window.

9. The method of claim 1, wherein the determining of the output path includes:
when a second application is executed, determining an output path for the second application according to a predetermined output unit for the second application.

10. The method of claim 9, wherein the determining of the predetermined output unit includes:
when the predetermined output unit is in use, recommending one or more second output units; and
determining the output path for the second application corresponding to an output unit selected by a user from among the recommended second output units.

11. The method of claim 9, wherein the determining of the predetermined output unit includes:
when the predetermined output unit is in use, receiving a user input that selects an output path for the second application; and
determining an output path for the second application corresponding to the selected output path.

12. The method of claim 1, further comprising:
determining, using a camera, whether a user associated with each window is visibly present; and
controlling an output value of the output unit based on the presence of the user or a location of the user.

13. The method of claim 1, further comprising:
recognizing, using a camera, a location of a user associated with each window in relation to the device; and
controlling an output value of the output unit on the basis of the recognized location.

14. A user interface apparatus in a multi-window, the apparatus comprising:
a path determining unit configured to determine an output path for each window contained in the multi-window; and
a signal providing unit configured to provide an output signal associated with each window to an output unit corresponding to the determined output path.

15. The apparatus of claim 14, wherein the path determining unit is further configured to determine the output path based on at least one of a display region of each window, an orientation of an application and a disposition of an application executing in each window.

16. The apparatus of claim 14, wherein the path determining unit is further configured to identify a characteristic of an application executing in each window and to determine the output path based on the identified characteristic.

17. The apparatus of claim 14, wherein the path determining unit is further configured to provide a list of output units, to receive a user response that selects an output unit in the list, and to determine the output path corresponding to the selected output unit.

18. The apparatus of claim 14, wherein the path determining unit is further configured to, when a second application is executed, receive a user input that selects a window for displaying the second application, and to determine an output path for the second application corresponding to an output path associated with the selected window.

19. The apparatus of claim 14, wherein the signal providing unit is further configured to, when a second application is executed, determine an output path for the second application according to a predetermined output unit for the second application.

20. The apparatus of claim 14, further comprising:
a control unit configured to determine, using a camera, whether a user associated with each window is visibly present, and to control an output value of the output unit based on the presence of the user or a location of the user.
